(19) United States
(12) Patent Application Publication
(10) Pub. No.: US 2024/0306221 A1
(43) Pub. Date: Sep. 12, 2024

(54) AGGREGATION LINK ESTABLISHMENT AND RELEASE FOR WIRELESS COMMUNICATIONS

(71) Applicant: ZTE Corporation, Shenzhen (CN)

(72) Inventors: Shuaihua KOU, Shenzhen (CN); Xianghui HAN, Shenzhen (CN); Peng HAO, Shenzhen (CN)

(73) Assignee: ZTE Corporation, Shenzhen, GD (CN)

(21) Appl. No.: 18/606,974

(22) Filed: Mar. 15, 2024

Related U.S. Application Data
(63) Continuation of application No. PCT/CN2022/071933, filed on Jan. 14, 2022.

(51) Int. Cl. H04W 76/10; H04W 48/02; H04W 48/20; H04W 76/30

(52) U.S. Cl. CPC H04W 76/10; H04W 48/02; H04W 48/20; H04W 76/30

(57) ABSTRACT

This document generally relates to wireless communication with an aggregation link between user devices. A first user device sends a request to establish the aggregation link with a second user device to a wireless access node. The request includes at least one transport protocol and at least one of a first identification of the first user device or a second identification of the second user device. In response to receiving the request, the wireless access node determines the second user device, and requests that the first and second user devices establish the aggregation link, such as by sending a configuration of the aggregation link. The first and second user devices establish the aggregation link, and communicate data over the aggregation link.

### CROSS-REFERENCE TO RELATED APPLICATIONS

This application is a continuation of International Patent Application No. PCT/CN2022/071933, filed Jan. 14, 2022. The contents of International Patent Application No. PCT/CN2022/071933 are herein incorporated by reference in their entirety.

### TECHNICAL FIELD

This document is directed generally aggregation links for wireless communication between user devices.

### BACKGROUND

New Radio (NR) supports various types of user devices, examples of which include mobile devices, wearable devices, customer premises equipment, vehicular devices, and Internet of Things (IoT) devices. These different types of user devices have different capabilities than each other, and some types may not be able to support as high of performance capabilities, such as transmit power, bandwidth, data rate, or uplink coverage, as possible. As such, ways for user devices to communicate at higher data rates than their performance capabilities otherwise dictates may be desirable.

### SUMMARY

This document relates to methods, systems, apparatuses and devices for wireless communication. In some implementations, a method for wireless communication comprises: receiving, with a wireless access node, a request to establish an aggregation link from a first user device, the request comprising at least one transport protocol and at least one of: a first identification of the first user device or a second identification of a second user device; in response to receiving the request, determining, with the wireless access node, a second user device; and requesting, with the wireless access node, the first user device and the second user device to establish the aggregation link with each other.

In other implementations, a method for wireless communication comprises: sending, with a first user device, a request to establish an aggregation link to a wireless access node, the request comprising at least one transport protocol and at least one of: a first identification of the first user device or a second identification of a second user device; in response to sending the request to establish the aggregation link, receiving, with the first user device, a configuration of the aggregation link; establishing, with the first user device, the aggregation link with the second user device according to the configuration; and upon establishing the aggregation link, exchanging, with the first user device, data with the second user device over the aggregation link.

In some other implementations, a device, such as a network device, is disclosed. The device may include one or more processors and one or more memories, wherein the one or more processors are configured to read computer code from the one or more memories to implement any one of the methods above.

In yet some other implementations, a computer program product is disclosed. The computer program product may include a non-transitory computer-readable program medium with computer code stored thereupon, the computer code, when executed by one or more processors, causing the one or more processors to implement any one of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a flow chart of an example method for wireless communication that includes establishing an aggregation link.

FIG. 3 shows a flow chart of another example method for wireless communication that includes establishing an aggregation link.

FIG. 4 shows a flow chart of another example method for wireless communication that includes establishing an aggregation link.

FIG. 5 show a diagram illustrating at least some messages user devices and a wireless access node may communicate to establish an aggregation link.

FIG. 6 shows a flow chart of an example method for wireless communication that includes communicating a capability report and an identification between a user device and a wireless access node.

### DETAILED DESCRIPTION

The present description describes various embodiments of systems, apparatuses, devices, and methods for wireless communications involving aggregation links between user devices.

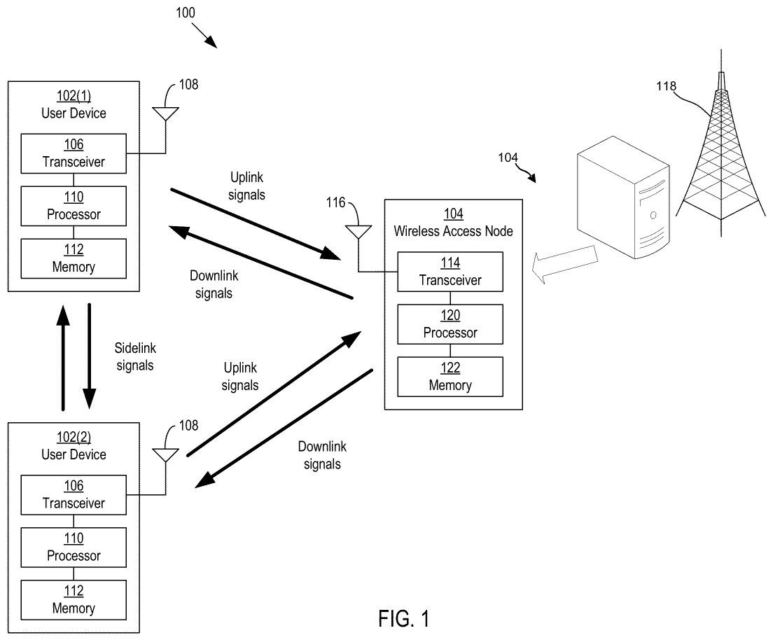

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of user devices 102 and wireless access nodes 104, including two or more user devices 102 without any wireless access nodes 104, only one user device 102 and only one wireless access node 104, only one user device 102 and two or more wireless access nodes 104, two or more user devices 102 and one or more wireless access nodes 104, or two or more wireless access nodes 104 without any user devices 102.

In general, a user device as described herein, such as the user devices 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

Additionally, as used herein, a direct connection or link over or via which two user devices 102 communicate (transmit and receive) sidelink signals is referred to as an aggregation link. When two user devices 102 establishe an aggregation link between each other, the two user devices 102 may directly communicate or exchange data or other information between them by communicating one or more sidelink signals over or via the aggregation link.

The following wireless communication apparatus, systems, and methods described with reference to the following flow charts and diagrams may allow user devices to establish and/or release aggregation links. Such apparatuses, systems, and/or methods may allow user devices, including those considered low capability user devices, to communicate at higher data transmission rates by establishing an aggregation link with another user device.

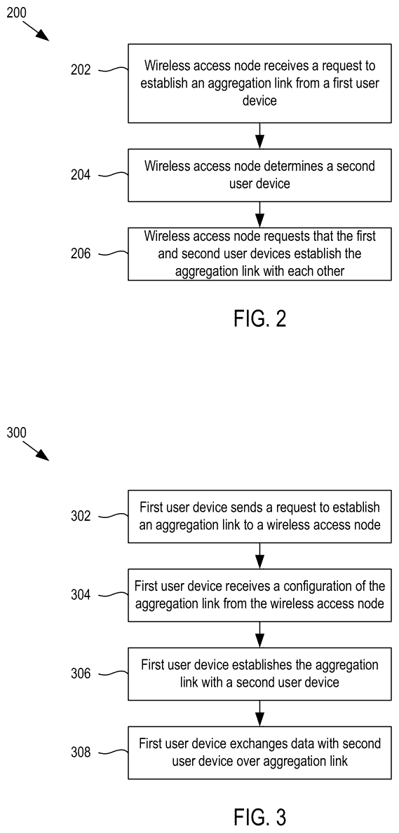

FIG. 2 shows an example method 200 for wireless communication that includes actions a wireless access node 104 may perform to establish an aggregation link between two user devices 102(1), 102(2). At block 202, the wireless access node 104 may receive a request to establish an aggregation link from the first user device 102(1). In various embodiments, the request may include at least one transport protocol and at least one of a first identification (ID) of the first user device 102(1) or a second identification (ID) of the second user device 102(2). The at least one transport protocol may indicate at least one expected transport protocol that the first user device 102(1) supports or expects to, or can, use to perform sidelink communications with another user device. Example transport protocols include, but non- limited to: WiFi (e.g., 802.11n, 802.11ac, 802.11ax), Bluetooth, Zigbee, LTE sidelink, or NR sidelink.

Also, for at least some embodiments, each transport protocol included in the request may be associated with the first ID and/or the first user device 102(1), which may indicate that each of the transport protocols identified in the request is an expected or supported transport protocol of the first user device 102(1). In addition or alternatively, each transport protocol included or indicated in the request may be associated with a respective one of at least one priority. The at least one priority and/or the association(s) between the at least one transport protocol and the at least one priority may be included or indicated in the request. Correspondingly, multiple transport protocols included in the request may have higher or lower priorities relative to each other corresponding to their associated priorities.

In addition or alternatively, the request may include at least one additional characteristic for the aggregation link. Example non-limiting characteristics for an aggregation link include: an operation bandwidth, a number of multiple-input, multiple-output (MIMO) layers, or a UE category. For at least some of these embodiments, each characteristic included or indicated in the request may be associated with a respective one of at least one priority. The at least one priority and/or the association(s) between the at least one characteristic and the at least one priority may be included or indicated in the request. Correspondingly, multiple characteristics included in the request may have higher or lower priorities relative to each other corresponding to their associated priorities.

In addition or alternatively, each combination of a transport protocol and a characteristic included in the request may have an associated priority. Correspondingly, for embodiments where the request includes multiple transport protocols and/or multiple characteristics, the request may have multiple unique combinations of transport protocols and characteristics, where any two combinations are different from each other by having different transport protocols and/or different characteristics. Additionally, for at least some of these embodiments, each combination included in the request may be associated with a respective one of at least one priority. The at least one priority and/or the association(s) between the at least one combination and the at least one priority may be included or indicated in the request. Correspondingly, multiple combinations included or indicated in the request may have higher or lower priorities relative to each other corresponding to their associated priorities.

At block 204, in response to receiving the request, the wireless access node 104 may determine a second user device 102(2) with which the first user device 102(1) should or is to establish the aggregation link. For embodiments where the request identifies the second ID of the second user device 102(2), the wireless access node 104 may determine the second user device 102(2) from the second ID included or indicated in the request. Additionally, for at least some embodiments where the request identifies the second ID, the request may further include a cell index of the second user device 102(2). In various embodiments, the cell index may include a physical cell identity or a global cell identity.

In other embodiments, the request may not include or indicate a second ID. For example, the request may only include or indicate the first ID of the first user device 102(1) that sent the request. The first user device 102(1) may send a request that includes the first ID but not the second ID for situations where the first user device 102(1) wants to establish an aggregation link with another user device, but does not know (has not identified) the particular user device with which to establish the aggregation link. For these embodiments, the wireless access node 104 may search for and/or select a suitable user device, such as from among one or more possible candidate, available, and/or known user devices. The second user device 102(2) that the wireless access node 104 determines at block 204 may be the suitable user device that the wireless access node 104 selects. Also, in various embodiments, the wireless access node 104 may select the suitable user device based on the at least one transport protocol, the at least one characteristic, or at least one combination thereof. For example, a suitable user device may support and/or be capable of communicating according to a transport protocol and/or a characteristic included or indicated in the request. Conversely, a user device that does not support and/or that is not capable of communicating according to a transport protocol and/or characteristic included or indicated in the request may be identified by wireless access node 104 as not a suitable user device. In at least some of these embodiments, if the wireless access node 104 identifies multiple suitable user devices, the wireless access node 104 may select the suitable user device based on priority, such as based on the priorities associated with the at least one transport protocol, the at least one characteristic, and/or the at least one combination included or indicated in the request. The wireless access node 104 may do so according to an order of highest priority. That is, the wireless access node 104 may select a suitable user device having a higher priority transport protocol, characteristic, or combination over one or more other suitable user devices having a lower priority transport protocol, characteristic, or combination. Among multiple suitable user devices, the wireless access node 104 may select a suitable user device having the highest priority first. In event that suitable user device is unavailable or otherwise unable to form an aggregation link with the first user device 102(1), then the wireless access node 104 may select a suitable user device having the next highest priority. If the wireless access node 104 ultimately cannot find a suitable user device, the wireless access node 104 may notify the first user device 102(1) that an aggregation link cannot be established and/or that there are no suitable user devices with which to form an aggregation link.

As a non-limiting example, suppose the request indicates that the first user device 102(1) supports the transport protocols NR sidelink and LTE sidelink, and that NR sidelink has a higher priority than LTE sidelink. In response to the request, the wireless access node 104 may first search for suitable user devices that support NR sidelink. If the wireless access node 104 does not identify any, then the wireless access node 104 may search for suitable user devices that support LTE sidelink. In addition or alternatively, if wireless access node 104 identifies a first suitable user device that supports NR sidelink and a second suitable user device that supports LTE sidelink (but not NR sidelink). In response, the wireless access node 104 may select the first suitable user device over the second suitable user device. In event that the first suitable user device is unable or not available to establish an aggregation link with the first user device 102(1), then the wireless access node 104 may then select the second suitable user device.

At block 206, the wireless access node 104 may request or instruct that the first user device 102(1) and the second user device 102(2) (i.e., the suitable user device it determined at block 204) establish the aggregation link. In some embodiments, including those where the request does not identify a second user device, the wireless access node 104 may send a first message to the second user device 102(2) that includes a configuration of the aggregation link. The configuration may include a configuration of a transport protocol. In addition or alternatively, the configuration may include a radio bearer configuration for the aggregation link, and/or a protocol stack configuration including at least one of: a physical layer configuration, a medium access control (MAC) configuration, a radio link control (RLC) configuration, a packet data convergence protocol (PDCP) configuration, or a radio resource control (RRC) configuration. Additionally, the first message may include the first ID of the first user device 102(1). The second user device 102(2) may treat the first message as an invitation to accept or reject an request to form an aggregation link with the first user device 102(1). Accordingly, upon receipt of the first message, the second user device 102(2) may accept or reject the invitation. If the second user device 102(2) accepts, then the wireless access node 104 may send a first configuration to the first user device 102(1). The first configuration includes the transport protocol for the aggregation link and the second ID of the second user device 102(2). The wireless access node 104 may also send a second message to the second user device 102(2) that instructs, prompts, or permits the second user device 102(2) to establish the aggregation link with the first user device 102(1) according to the transport protocol indicated in the first message.

In response to the first and second user devices 102(1), 102(2) establishing the aggregation link, the wireless access node 104 may receive an aggregation link establishment complete notification from one of the first and second user devices 102(1), 102(2). For at least some of these embodiments, the wireless access node 104 may respond by sending an aggregation link confirmation to the other of the first and second user devices 102(1), 102(2), which may prompt the other user device not to send its aggregation link establishment complete notification to the wireless access node 104. This way, both user devices 102(1), 102(2) do not send the aggregation link establishment complete notification to the wireless access node 104.

FIG. 3 shows an example method 300 for wireless communication that includes actions a first user device 102(1) may perform to establish an aggregation link with another, second user device 102(2). At block 302, the first user device 102(1) may send a request to establish to establish an aggregation link to the wireless access node 104. The request may include at least one transport protocol and at least one of: a first ID of the first user device 102(1) or a second ID of a second user device 102(2), such as a request to establish an aggregation link as previously described with respect to the example method 200 of FIG. 2.

At block 304, in response to sending the request, the first user device 102(1) may receive a configuration of the aggregation link from the wireless access node 104. The configuration may include a configuration for a transport protocol for the aggregation link. Also, for embodiments where the request did not include the second ID, the first user device 102(1) may receive the second ID of the second user device 102(2) with which the first user device 102(1) is to establish the aggregation link.

At block 306, the first user device 102(1) may establish the aggregation link with the second user device 102(2). For example, the first user device 102(1) may communicate any of various information, such as in accordance with any of various standard or specifications, with the second user device 102(2) to establish the aggregation link according to the transport protocol indicated from the wireless access node 104. For at least some embodiments, upon receipt of the configuration and/or second ID from the wireless access node 104, the first user device 102(1) may start a timer. In various embodiments, an expiration time for the timer may be included with the configuration information received from the wireless access node 104 at block 304. If the timer expires before the first user device 102(1) establishes the aggregation link with the second user device 102(2), then the first user device 102(1) may determine that it failed to establish the aggregation link with the second user device 102(2), and may notify the wireless access node 104 of the failure. Additionally, if the first user device 102(1) establishes the aggregation link with the second user device 102(2) before the timer expires, then the first user device 102(1) may send an aggregation link establishment complete notification to the wireless access node. However, if the first user device 102(1) receives an aggregation link confirmation from the wireless access node 104 before it sends the aggregation link establishment complete notification, then the first user device 102(1) may determine not to send the aggregation link establishment complete notification. At block 308, in response to establishing an aggregation link with the second user device 102(2), the first user device 102(1) may communicate or exchange data or other information with the second user device 102(2) over the aggregation link.

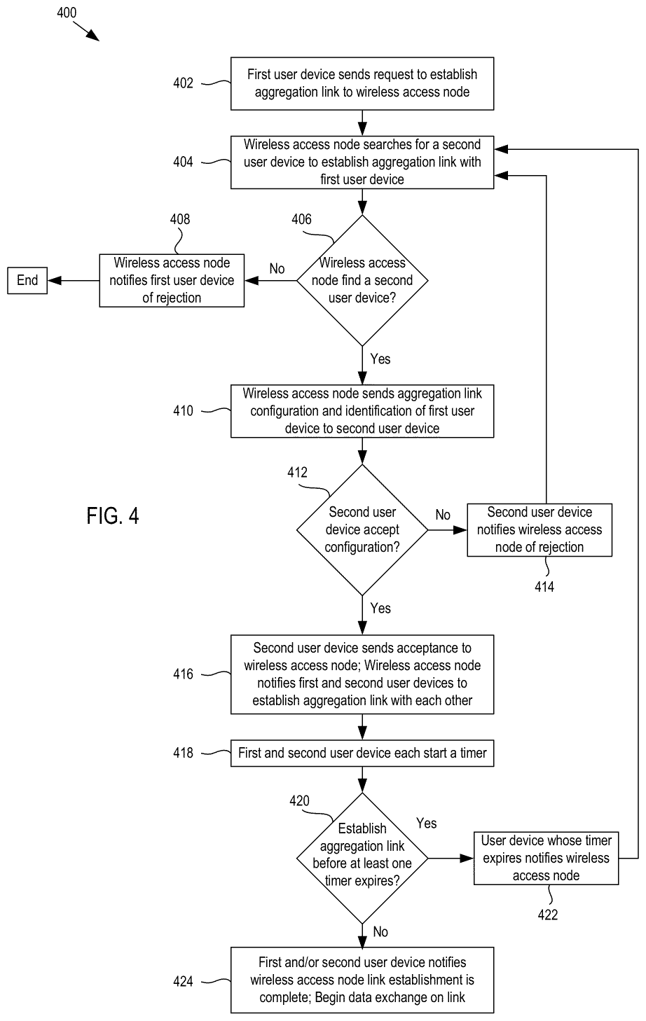

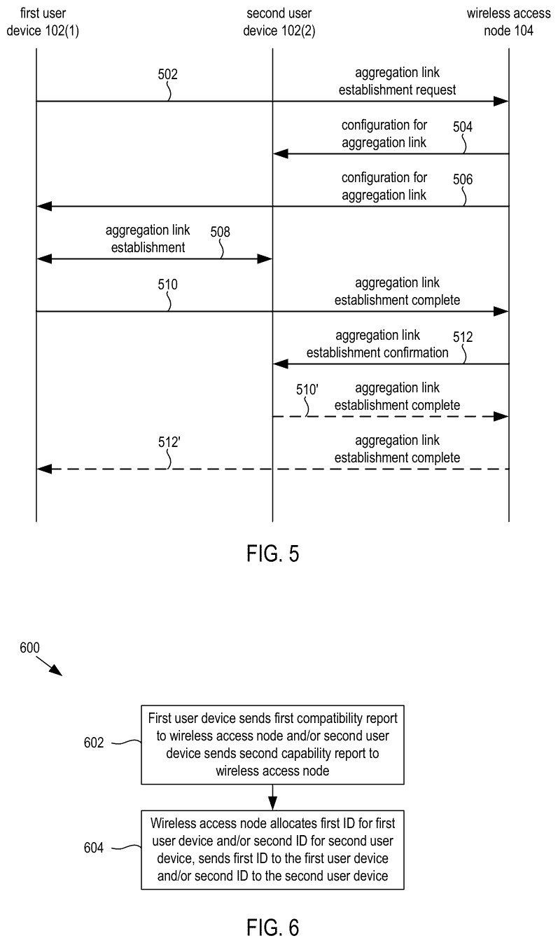

FIG. 4 shows another example method 400 for wireless communication that includes actions first user device 102(1), a second user device 102(2), and a wireless access node 104 may perform to establish an aggregation link between the first and second user device 102(1), 102(2). In various embodiments, the method 400 may be performed alone or in combination with or as part of the method 200 and/or the method 300. The method 400 is also described with reference to diagram 500 of FIG. 5, which illustrates at least some messages or other signals that the first user device 102(1), the second user device 102(2), and the wireless access node 104 communicate between each other in connection with the aggregation link between the first and second user devices 102(1), 102(2).

At block 402, and also indicated by arrow 502 in FIG. 5, the first user device 102(1) may send a request to establish an aggregation link to the wireless access node 104. The request may include at least one transport protocol and a first ID of the first user device 102(1), as previously described with respect to blocks 202 and 302 of FIGS. 2 and 3, respectively. Also, here in method 400, the first user device 102(1) may want to establish an aggregation link with another user device, but may not know the particular user device with which to establish the aggregation link. Accordingly, the request may include the first ID, but not the a second ID of a second user device 102(2). Additionally, in some embodiments, the request may include at least one characteristic of the aggregation link. Also, in some embodiments, the request may include or indicate at least one priority corresponding to at least one transport protocol, at least one characteristic, or at least one combination of the two, as previously described.

At block 404, the wireless access node 104, in response to receipt of the request, may search for a suitable user device with which the first user device 102(1) may form the aggregation link. As previously described, the wireless access node 104 may do so by looking for a user device that supports the at least one transport protocol, the at least one characteristic, or the at least one combination of the two. In event that the wireless access node 104 identifies multiple suitable user devices, the wireless access node 104 may select a suitable user device from among the multiple suitable user devices in an order of highest priority, as previously described. The wireless access node 104 may identify the suitable user device that it selects as the second user device 102(2) for forming the aggregation link with the first user device 102(1). At block 406, if the wireless access node 104 does not identify a suitable user device, then at block 408, the wireless access node 104 may determine to reject the request, and notify the first user device 102(1) of the rejection.

Alternatively, at block 406, if the wireless access node 102 identifies a second user device 102(2), then at block 410, also shown by arrow 504 in FIG. 5, the wireless access node 104 may send a first message that includes a configuration of the aggregation link to the second user device 102(2). The wireless access node 104 may also send the first ID of the first user device 102(1) to the second user device 102(2). At block 412, the second user device 102(2) may receive the configuration, and determine whether to accept the configuration, or in other words, agree to establish the aggregation link with the first user device 102(1). If the second user device 102(2) determines not to establish the aggregation link, then the second user device 102(2) may notify the wireless access node 104 of its decision to reject establishing the aggregation link. For at least some embodiments, the method 400 may proceed back to block 404, where the wireless access node 104 may search for another suitable user device.

Alternatively, at block 412, if the second user device 102(2) determines to establish the aggregation link, then at block 416, the second user device sends an acceptance to the wireless access node 104. In response to receipt of the acceptance, the wireless access node 104 may notify the first and second user devices 102(1), 102(2) to establish the aggregation link. The wireless access node 104 may notify the first user device 102(2) by sending a configuration of the aggregation link and a second identification of the second user device 102(2), which is shown by arrow 506 in FIG. 5. The wireless access node 104 may also send an additional notification or instruction to the second user device 102(2) that instructs the second user device 102(2) to form the aggregation link with the first user device 102(1).

At block 418, in response to being notified to establish the aggregation link, the first and second user devices 102(1), 102(2) may each start a respective timer. In some embodiments, the wireless access node 104 may provide an expiration value for the timers to the first and second user devices 102(1), 102(2). At block 420, if at least one of the timers of the first and second user devices 102(1), 102(2) expires before the first and second user devices 102(1), 102(2) establish the aggregation link, then at block 422, the user device 102 whose timer expired may notify the wireless access node 104 that the first and second user devices 102(1), 102(2) failed to establish the aggregation link within a desired time period as set by the timer. For at least some embodiments, the method 400 may proceed back to block 404 where the wireless access node 104 searches for another suitable user device.

Alternatively, at block 420, if the first and second user devices 102(1), 102(2) establish the aggregation link before the timers expire, as shown by arrow 508 in FIG. 5, then at block 424, the first and second user devices 102(1), 102(2) may exchange data or other information with each other over the aggregation link. Also, in some embodiments, one of the first or second user devices 102(1), 102(2) may notify the wireless access node 104 that the aggregation link is established, such as by sending an aggregation link establishment complete notification to the wireless access node 104. In response to receipt of the complete notification, the wireless access node 104 may send an aggregation link confirmation to the other of the first and second user devices 102(1), 102(2). In FIG. 5, arrow 510 shows the first user device 102(1) sending the aggregation link establishment complete notification to the wireless access node, and arrow 512 shows the wireless access node 104 sending the aggregation link establishment confirmation to the second user device 102(2). In the alternative, arrow 510′ shows the second user device 102(2) sending the aggregation link establishment complete notification to the wireless access node 104, and arrow 512′ shows the wireless access node 104 sending the aggregation link establishment confirmation to the first user device 102(1). The other user device 102, in response to receipt of the aggregation link confirmation, may determine not to send its aggregation link establishment complete notification to the wireless access node 104. This way, both user devices 102(1), 102(2) do not have to send an aggregation link establishment complete notification to the wireless access node 104.

As described, in the example method 400, the first user device 102(1) may request to establish an aggregation link with a user device, without knowing the particular user device with which to establish the aggregation link. In other embodiments, the first user device 102(2) may know or have identified the second user device 102(2) with which it wants to establish the aggregation link. For at least some of these other embodiments, the first user device 102(1) may have already established a connection with the second user device 102(2) before it sends the request to establish the aggregation link with the second user device 102(2). In such situations, the first user device 102(2) may know the second ID of the second user device 102(2) before sending the request to the wireless access node 104, and may include the second ID of the second user device 102(2) in the request. For at least some of these embodiments, the request may further include a cell index of the second user device 102(2). In various of these embodiments, the cell index may include a physical cell identity or a global cell identity. The wireless access node 104 may respond to the request by sending configurations of the aggregation link to each of the first and second user devices 102(1), 102(2), such as indicated by arrows 504, 506 in FIG. 5. The first and second user devices 102(1), 102(2) may then proceed to set timers and establish the aggregation link, as previously described.

Additionally, in some embodiments, the first user device 102(1) may be configured to communicate with the wireless access node 104 via the second user device 102(2). For at least some embodiments, the first user device 102(1) may determine it wants to establish an aggregation link with the second user device 102(2). Rather than send a request directly to the wireless access node 104, the first user device 102(1) may send the request, including its first ID, to the second user device 102(2). In response, the second user device 102(2) may forward the request to the wireless access node 104. The wireless access node 104 may respond by sending both a first configuration of the aggregation link for the first user device 102(1) and a second configuration of the aggregation link for the second user device 102(2) to the second user device 102(2). The second user device 102(2) may then forward the first configuration to the first user device 102(1). In turn, the first and second user devices 102(1), 102(2) may establish the aggregation link, as previously described. Also, for some of these embodiments, the first user device 102(1) may send a radio resource control (RRC) setup request to the second user device 102(1). The RRC setup request may include the request to establish the aggregation link. Upon receipt of the RRC setup request, the second user device 102(2) may forward the RRC setup request to the wireless access node 104. The wireless access node 104 may respond by sending configurations of the aggregation link for the first and second user devices 102(1), 102(2) to the second wireless access node 102(2), as previously described.

In various other embodiments, the first user device 102(1) may send a RRC setup request directly to the wireless access node 104, i.e., without sending the RRC setup request to the second user device 102(2). As mentioned, the RRC setup request may include the request to establish the aggregation link.

Additionally, in some embodiments, after establishing an aggregation link, the first user device 102(1) and/or the second user device 102(2) may determine to no longer have the aggregation link—i.e., that it wants the aggregation link terminated or released. For example, the first user device 102(1) and/or the second user device 102(2) may determine it does not need the aggregation link for data communication anymore, or the aggregation link breaks down. In response, the first user device 102(1) or the second user device 102(2) may send an aggregation link release request to the wireless access node 104. In response, the wireless access node 104 may send a first message to the first user device 102(1) that includes an aggregation link release configuration for the first user device 102(1) to release the aggregation link, and may send a second message to the second user device 102(2) that includes an aggregation link release configuration for the second user device 102(2) to release the aggregation link. In addition or alternatively, the wireless access node 104 may initiate the aggregation link release, such as by sending the first message to the first user device 102(1) and sending the second message to the second user device 102(2), without receiving the request from the first user device 102(1) or the second user device 102(2). Additionally, in some embodiments, one of the user devices 102(1), 102(2) may experience a radio link failure or not be able to connect with the wireless access node 104. In response, that user device may send an indication to the other user device, and the other user device may send an aggregation release request to the wireless access node 104.

FIG. 6 shows another example method 600 for wireless communication. At block 602, the first user device 102(1) may send a first capability report to the wireless access node 104, and/or the second user device 102(2) may send a second capability report to the wireless access node 104. In general, a capability report sent by a user device 102 to the network (wireless access node 104) informs the wireless access node 104 what transport protocols the first user device 102 supports for an aggregation link. Accordingly, the capability report may include or indicate one or more transport protocols that the user device 102 supports. At block 604, in response to the receipt of the first capability report, the wireless access node 104 may allocate a first ID or index for the first user device 102(1), and may send the first ID to the first user device 102(1). In addition or alternatively, in response to receipt of the second capability report, the wireless access node 104 may allocate a second ID or index for the second user device 102(2), and may send the second ID to the second user device 102(2). This way, the first user device 102(1) and/or the second user device 102(2) has an ID when it wants to request establishment of an aggregation link. In addition or alternatively, by allocating IDs for user devices upon receipt of capability reports, the wireless access node 104 may know IDs of possible suitable user devices to establish an aggregation link with a user device that sends a request to establish an aggregation link. Accordingly, in various embodiments, the method 600 may be performed as part of any of methods 200, 300, 400 of FIGS. 2, 3, 4, respectively, such as before the first user device 102(1) sends and/or the wireless access node 104 receives the request at blocks 202, 302, 402, respectively.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: receiving, with a wireless access node, a request to establish an aggregation link from a first user device, the request comprising at least one transport protocol and at least one of: a first identification of the first user device or a second identification of a second user device; in response to receiving the request, determining, with the wireless access node, a second user device; and requesting, with the wireless access node, the first user device and the second user device to establish the aggregation link with each other.

A second aspect includes the first aspect and further includes: receiving, with the wireless access node, at least one of a first capability report from the first user device or a second capability report from the second user device, the first capability report indicating that the first user device supports the at least one transport protocol for the aggregation link, the second capability report indicating that the second user device supports the at least one transport protocol for the aggregation link.

A third aspect includes the second aspect and further includes: allocating, with the wireless access node, the first identification to the first user device in response to receiving the first capability report from the first user device; or allocating, with the wireless access node, the second identification to the second user device in response to receiving the second capability report from the second user device.

A fourth aspect includes any of the first through third aspects, and further includes wherein the request further comprises at least one priority, wherein each of the at least one priority corresponds to a respective one of the at least one transport protocol.

A fifth aspect includes any of the first through fourth aspects, and further includes wherein the request further comprises at least one additional characteristic for the aggregation link.

A sixth aspect includes the fifth aspect and further includes wherein the request further comprises at least one priority, wherein each of the at least one priority corresponds to a respective one of the at least one additional characteristic for the aggregation link.

A seventh aspect includes the fifth aspect and further includes wherein the request further comprises at least one priority, wherein each of the at least one priority corresponds to a respective one of at least one combination of the at least one transport protocol and the at least one characteristic.

An eighth aspect includes any of the first through seventh aspects, and further includes wherein determining the second user device comprises: selecting, with the wireless access node, a suitable user device corresponding to the request, wherein the second user device is the suitable user device that the wireless access node selects.

A ninth aspect includes the eighth aspect, and further includes wherein selecting the suitable user device comprises selecting, with the wireless access node, selecting the suitable user device according to at least one priority included in the request.

A tenth aspect includes any of the eighth or ninth aspects, and further includes wherein the suitable device comprises a first suitable user device, and selecting, with the wireless access node, a second suitable user device in response to receiving a rejection from the first suitable user device.

An eleventh aspect includes any of the first through tenth aspects, and further includes: sending, with the wireless access node, a first message to the second user device, the first message comprising a configuration of the aggregation link and the identifier of the first user device.

A twelfth aspect includes any of the first through eleventh aspects, and further includes wherein requesting the first user device and the second user device to establish the aggregation link comprises: sending, with the wireless access node, a configuration of the aggregation link and an identifier of the second user device to the first user device.

A thirteenth aspect includes any of the first through twelfth aspects, and further includes wherein requesting the first user device and the second user device to establish the aggregation link further comprises: sending, with the wireless access node, a second message to the second user device that indicates to the second user device to establish the aggregation link with the first user device according to a configuration of the aggregation link.

A fourteenth aspect includes any of the first through thirteenth aspects, and further includes: receiving, with the wireless access node, an aggregation link establishment complete notification from one of the first and second user devices; and in response to receiving the aggregation link establishment complete notification, sending, with the wireless access node, an aggregation link confirmation to the other of the first and second user devices.

A fifteenth aspect includes the first aspect, and further includes wherein the request to establish the aggregation link comprises both the first identification of the first user device and the second identification of the second user device, wherein determining the second user device comprises determining, with the wireless access node, the second user device from the second identification in the request.

A sixteenth aspect includes the fifteenth aspect, and further includes wherein the request further comprises a cell index of the second user device, the cell index comprising a physical cell identity or a global cell identity.

A seventeenth aspect includes any of the first through sixteenth aspects, and further includes: receiving, with the wireless access node, a radio resource control (RRC) setup request from the first user device or the second user device, wherein the RRC setup request comprises the request to establish the aggregation link.

An eighteenth aspect includes any of the first through seventeenth aspects, and further includes: receiving, with the wireless access node, an aggregation link release request from the first user device or the second user device; and in response to receiving the aggregation link release request, sending, with the wireless access node, messages to the first and second user devices comprising release configuration information that indicates to each of the first user device and the second user device to release the aggregation link.

A nineteenth aspect includes a method for wireless communication that includes: sending, with a first user device, a request to establish an aggregation link to a wireless access node, the request comprising at least one transport protocol and at least one of: a first identification of the first user device or a second identification of a second user device; in response to sending the request to establish the aggregation link, receiving, with the first user device, a configuration of the aggregation link; establishing, with the first user device, the aggregation link with the second user device according to the configuration; and upon establishing the aggregation link, exchanging, with the first user device, data with the second user device over the aggregation link.

A twentieth aspect includes the nineteenth aspect, and further includes in response to sending the request to establish the aggregation link, receiving, with the first user device, the second identification of the second user device from the wireless access node.

A twenty-first aspect includes any of the nineteenth or twentieth aspects, and further includes: sending, with the first user device, a capability report to the wireless access node, the capability report indicating that the first user device supports the at least one transport protocol; and in response to sending the capability report, receiving, with the first user device, the first identification from the wireless access node.

A twenty-second aspect includes any of the nineteenth through twenty-first aspects, and further includes: starting, with the first user device, a timer in response to receiving the configuration of the aggregation link from the wireless access node; in response to establishing the aggregation link and the timer not expiring, stopping, with the first user device, the timer; and in response to not establishing the aggregation link when the timer expires, detecting, with the first user device, a failure to establish the aggregation link with the second user device.

A twenty-third aspect includes any of the nineteenth through twenty-second aspects, and further includes: receiving, with the first user device, an aggregation link confirmation from the wireless access node before the first user device sends an aggregation link establishment complete notification to the wireless access node.

A twenty-fourth aspect includes any of the nineteenth or twenty-first through twenty-third aspects, and further includes wherein the request to establish the aggregation link comprises both the first identification of the first user device and the second identification of the second user device.

A twenty-fifth aspect includes the twenty-fourth aspect, and further includes wherein the request further comprises a cell index of the second user device comprising a physical cell identity or a global cell identity.

A twenty-sixth aspect includes any of the nineteenth through twenty-fifth aspects, and further includes: receiving, with the first user device, the request to establish the aggregation link from the second user device, wherein sending, with the first user device, the request to establish the aggregation link to the wireless access node is in response to receiving the request from the second user device.

A twenty-seventh aspect includes any of the nineteenth through twenty-sixth aspects, and further includes: receiving, with the first user device, a radio resource control (RRC) setup request from a second user device; and in response to the receiving the RRC setup request from the second user device, sending, with the first user device, the RRC setup request to the wireless access node, wherein the RRC setup request comprises the request to establish the aggregation link.

A twenty-eighth aspect includes any of the nineteenth through twenty-seventh aspects, and further includes: sending, with the first user device, an aggregation link release request to the wireless access node; and receiving, with the first user device, a message comprising release configuration information from the wireless access node, the release configuration information comprising information that indicates to the first user device to release the aggregation link.

A twenty-ninth aspect includes any of the nineteenth through twenty-eighth aspects, and further includes: determining, with the first user device, that the second user device is unable to connect to the wireless access node, wherein sending, with the first user device, the aggregation link release request to the wireless access node is in response to determining that the second user device is unable to connect to the wireless access node.

A thirtieth aspect includes a wireless communications apparatus comprising a processor and a memory, wherein the processor is configured to read code from the memory to implement any of the first through thirtieth aspects.

A thirty-first aspect includes a computer program product comprising a computer-readable program medium comprising code stored thereupon, the code, when executed by a processor, causing the processor to implement any of the first through thirty-first aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
receiving, with a wireless access node, a request to establish an aggregation link from a first user device, the request comprising at least one transport protocol and at least one of: a first identification of the first user device or a second identification of a second user device;
in response to receiving the request, determining, with the wireless access node, a second user device; and
requesting, with the wireless access node, the first user device and the second user device to establish the aggregation link with each other.

2. The method of claim 1, further comprising:
receiving, with the wireless access node, at least one of a first capability report from the first user device or a second capability report from the second user device, the first capability report indicating that the first user device supports the at least one transport protocol for the aggregation link, the second capability report indicating that the second user device supports the at least one transport protocol for the aggregation link.

3. The method of claim 2, further comprising:
allocating, with the wireless access node, the first identification to the first user device in response to receiving the first capability report from the first user device; or
allocating, with the wireless access node, the second identification to the second user device in response to receiving the second capability report from the second user device.

4. The method of claim 1, wherein the request further comprises at least one priority, wherein each of the at least one priority corresponds to a respective one of the at least one transport protocol.

5. The method of claim 1, wherein the request further comprises at least one additional characteristic for the aggregation link.

6. The method of claim 5, wherein the request further comprises at least one priority, wherein each of the at least one priority corresponds to a respective one of the at least one additional characteristic for the aggregation link.

7. The method of claim of claim 5, wherein the request further comprises at least one priority, wherein each of the at least one priority corresponds to a respective one of at least one combination of the at least one transport protocol and the at least one characteristic.

8. The method of claim 1, wherein determining the second user device comprises:
selecting, with the wireless access node, a suitable user device corresponding to the request, wherein the second user device is the suitable user device that the wireless access node selects.

9. The method of claim 8, wherein selecting the suitable user device comprises selecting, with the wireless access node, selecting the suitable user device according to at least one priority included in the request.

10. The method of claim 8, wherein the suitable device comprises a first suitable user device, the method further comprising:
selecting, with the wireless access node, a second suitable user device in response to receiving a rejection from the first suitable user device.

11. The method of claim 1, further comprising:
sending, with the wireless access node, a first message to the second user device, the first message comprising a configuration of the aggregation link and the identifier of the first user device.

12. The method of claim 1, wherein requesting the first user device and the second user device to establish the aggregation link comprises:
sending, with the wireless access node, a configuration of the aggregation link and an identifier of the second user device to the first user device.

13. The method of claim 1, wherein requesting the first user device and the second user device to establish the aggregation link further comprises:
sending, with the wireless access node, a second message to the second user device that indicates to the second user device to establish the aggregation link with the first user device according to a configuration of the aggregation link.

14. The method of claim 1, further comprising:
receiving, with the wireless access node, an aggregation link establishment complete notification from one of the first and second user devices; and
in response to receiving the aggregation link establishment complete notification, sending, with the wireless access node, an aggregation link confirmation to the other of the first and second user devices.

15. The method of claim 1, wherein the request to establish the aggregation link comprises both the first identification of the first user device and the second identification of the second user device, wherein determining the second user device comprises determining, with the wireless access node, the second user device from the second identification in the request.

16. The method of claim 15, wherein the request further comprises a cell index of the second user device, the cell index comprising a physical cell identity or a global cell identity.

17. The method of claim 1, further comprising:
receiving, with the wireless access node, a radio resource control (RRC) setup request from the first user device or the second user device, wherein the RRC setup request comprises the request to establish the aggregation link.

18. The method of claim 1, further comprising:
receiving, with the wireless access node, an aggregation link release request from the first user device or the second user device; and
in response to receiving the aggregation link release request, sending, with the wireless access node, messages to the first and second user devices comprising release configuration information that indicates to each of the first user device and the second user device to release the aggregation link.

19. A method for wireless communication, the method comprising:
sending, with a first user device, a request to establish an aggregation link to a wireless access node, the request comprising at least one transport protocol and at least one of: a first identification of the first user device or a second identification of a second user device;
in response to sending the request to establish the aggregation link, receiving, with the first user device, a configuration of the aggregation link;
establishing, with the first user device, the aggregation link with the second user device according to the configuration; and
upon establishing the aggregation link, exchanging, with the first user device, data with the second user device over the aggregation link.

20. The method of claim 19, further in response to sending the request to establish the aggregation link, receiving, with the first user device, the second identification of the second user device from the wireless access node.

21-31. (canceled)
